(19) United States
(12) Patent Application Publication
(10) Pub. No.: US 2007/0163314 A1
(43) Pub. Date: Jul. 19, 2007

(54) Lock Driving Mechanism

(76) Inventor: Ping-Hung Hsieh, Kaohsiung Hsien (TW)

Correspondence Address: ELIZABETH CHIEN-HALE, 40087 MISSION BLVD. BOX 367, FREMONT, CA, 94539, US

(21) Appl. No.: 11/277,490

(22) Filed: Mar. 25, 2006

(30) Foreign Application Priority Data
Oct. 25, 2005 (TW) 094218386

(51) Int. Cl. E05B 15/12

(52) U.S. Cl. 70/322

(57) ABSTRACT

A lock driving mechanism for use in a lock has an inner driving member having an inner panel, and a outer driving member attached to the inner panel and having an outer panel. The inner panel has an inner surface from which a lock core driver extends and connects to a lock core assembly of the lock and an outer surface on which an inner driver and an outer driver are formed. The outer panel has an inner surface on which an inner limiting protrusion and an outer limiting protrusion are formed, and an outer surface from which a latch driver extends to connect with a latch bolt of the lock. When a key inserted into the lock core assembly rotates, the inner and outer driver rotate, synchronously push the inner and an outer bump, respectively, to make the key and latch driver rotate smoothly to drive the latch bolt to lock or unlock a door.

### BACKGROUND OF THE INVENTION

1. Field of the Invention

The present invention relates to a lock, and more particularly to a lock driving mechanism for use in a lock.

2. Description of the Related Art

A unique key is used to unlock a corresponding lock. Sometimes, the key has to be changed, which necessitates changing the entire lock. For a common example, a landlord usually has to change door locks when a tenant moves out and a new tenant moves in. Changing the entire lock is not economical, so a lock with a replaceable lock core assembly was invented. When the key is changed, changing the whole lock is not necessary and replacing the lock core assembly is more economical.

With reference to FIGS. 11-13, a lock has a cylindrical housing (60), a lock core assembly (not shown), a round panel (66), a lock driving mechanism (61), a spring (65), a fastening member (64) and a latch bolt (not shown).

The cylindrical housing (60) is hollow, is mounted in a door (not shown) and has an inner surface (not numbered) and a receiving hole (601). The receiving hole (601) is defined in the inner surface of the cylindrical housing (60).

The lock core assembly is held rotatably in the cylindrical housing (60), and a corresponding key can be inserted into and rotate the lock core assembly.

The round panel (66) is held rotatably in the receiving hole (601) and has a slot (661). The slot (661) is defined in the round panel (66).

The lock driving mechanism (61) has an inner driving member (62) and an outer driving member (63).

The inner driving member (62) has an inner panel (621) and two inner arms (622). The inner panel (621) has two shoulders (623), a head (624), an inner surface (not numbered) and an outer surface (not numbered). The head (624) protrudes between the shoulders (623) and has two sides (not numbered). The inner surface of the inner panel (621) abuts the round panel (66). The inner arms (622) extend laterally from the two sides of the head (624), insert through the slot (661) of the round panel (66) and is connected with the lock core assembly inside the cylindrical housing (60). When the corresponding key inserts into the lock core assembly, the corresponding key inserts between the two inner arms (622). Further, rotating the corresponding key rotates the inner arms (622) and inner panel (621) in the meanwhile.

The outer driving member (63) has an outer panel (631), a bulge (633) and an outer arm (632). The outer panel (631) has an inner surface (not numbered) and an outer surface (not numbered). The bulge (633) protrudes laterally from the inner surface of the outer panel (631). The outer arm (632) extends laterally from the outer surface of the outer panel (631). When the inner panel (621) rotates, one of the shoulders pushes the bulge (633) to rotate the outer panel (631) and outer arm (632). The inner surface of the outer panel (631) abuts the outer surface of the inner panel (321).

The spring is put around the outer arm (632) of the outer driving member (63) to make the inner surface of the outer panel (631) abut the outer surface of the inner panel (621).

The fastening member (64) is mounted on the inner surface of the cylindrical housing (60) and has a through hole (641). The outer arm (632) extends through the through hole (641).

The latch bolt is connected to the outer arm (632) of the outer driving member (63) outside the cylindrical housing (60). The rotary outer arm (632) controls the latch bolt to lock or unlock the door.

Rotating the corresponding key can extend or retract the latch bolt lock However, in the rotating process of the lock driving mechanism (61), only one of the shoulders (623) pushes the bulge (633) to rotate the outer driving member (63). Thus, a moment imposed by one of the shoulders (623) only concentrates on the bulge (633) but not distributes symmetrically over the outer panel (631). The moment is irregular and cannot make the outer panel (631) rotate smooth.

### SUMMARY OF THE INVENTION

The primary objective of the present invention is to provide a lock driving mechanism to connect a lock core assembly to a latch bolt of a lock, to smoothly drive the latch bolt.

The lock driving mechanism in accordance with the present invention is held in a cylindrical housing of the lock.

The cylindrical housing is mounted in a door and has an inner surface and a receiving hole. The receiving hole is defined in the inner surface of the cylindrical housing.

The lock driving mechanism is held rotatably in the receiving hole in the cylindrical housing and has an inner driving member and an outer driving member.

The inner driving member has an inner panel, a lock core driver, an inner driver and an outer driver. The inner panel has a center, an imaginary inner circle, an imaginary outer circle, an inner surface and an outer surface. The imaginary inner circle and imaginary outer circle are concentric circles centered at the center of the inner panel. The lock core driver has at least one inner arm extending from the inner surface of the inner panel and being connected with the lock core assembly. The inner driver has two stop portions formed on the outer surface on the imaginary inner circle of the inner panel. The outer driver has two stop portions formed on the outer surface on the imaginary outer circle of the inner panel.

The outer driving member engages the inner driving member and has an outer panel, an inner bump, an outer bump and a latch driver. The outer panel has a center, an imaginary inner circle, an imaginary outer circle, an inner surface and an outer surface. The center of the outer panel corresponds to the center of the inner panel. The imaginary inner circle and imaginary outer circle on the outer panel corresponding to the imaginary inner circle and imaginary outer circle on the inner panel. The inner bump is formed on the inner surface on the imaginary inner circle on the outer panel. The outer bump is formed on the inner surface on the imaginary outer circle on the outer panel. The latch driver has at least one outer arm extending from the outer surface of the outer panel. The at least one outer arm is connected to and extends or retracts the latch bolt.

When a corresponding key inserted into the lock core assembly is turned, the lock core driver rotates such that one of the inner stop portions of the inner driver and one of the outer stop portions of the outer driver rotate to synchronously push the inner bump and outer bump, respectively. Thus, a moment generated by the rotating corresponding key is divided between the inner bump and outer bump, to make the corresponding key and latch driver rotate smoothly to drive the latch bolt to lock or unlock the door.

### BRIEF DESCRIPTION OF THE DRAWINGS

FIG. 1 is an exploded perspective view of a first embodiment of a lock driving mechanism in accordance with the present invention;

FIG. 2 is an enlarged rear view of an inner driving member of the lock driving mechanism in FIG. 1;

FIG. 3 is an enlarged front view of an outer driving member of the lock driving mechanism in FIG. 1;

FIG. 4 is an exploded perspective view of a second embodiment of the lock driving mechanism in accordance with the present invention;

FIG. 5 is a cross-sectional rear view of the lock driving mechanism in FIG. 1;

FIG. 6 is a cross-sectional rear view of the lock driving mechanism in FIG. 4;

FIG. 7 is a top view in partial section of the lock driving mechanism along line 7-7 in FIG. 6;

FIG. 8 is an exploded perspective view of a third embodiment of the lock driving mechanism in accordance with the present invention;

FIG. 9 is an exploded perspective view of a forth embodiment of the lock driving mechanism in accordance with the present invention;

FIG. 10 is a exploded perspective view of a fifth embodiment of the lock driving mechanism in accordance with the present invention;

FIG. 11 is an exploded perspective view of a conventional lock driving mechanism in accordance with the prior art;

FIG. 12 is a side view in partial section of the conventional lock driving mechanism in FIG. 11; and

FIG. 13 is a top view in partial section of the conventional lock driving mechanism of FIG. 11.

### DETAILED DESCRIPTION OF THE PREFERRED EMBODIMENT

A lock driving mechanism in accordance with the present invention is used in a lock with a replaceable lock core assembly.

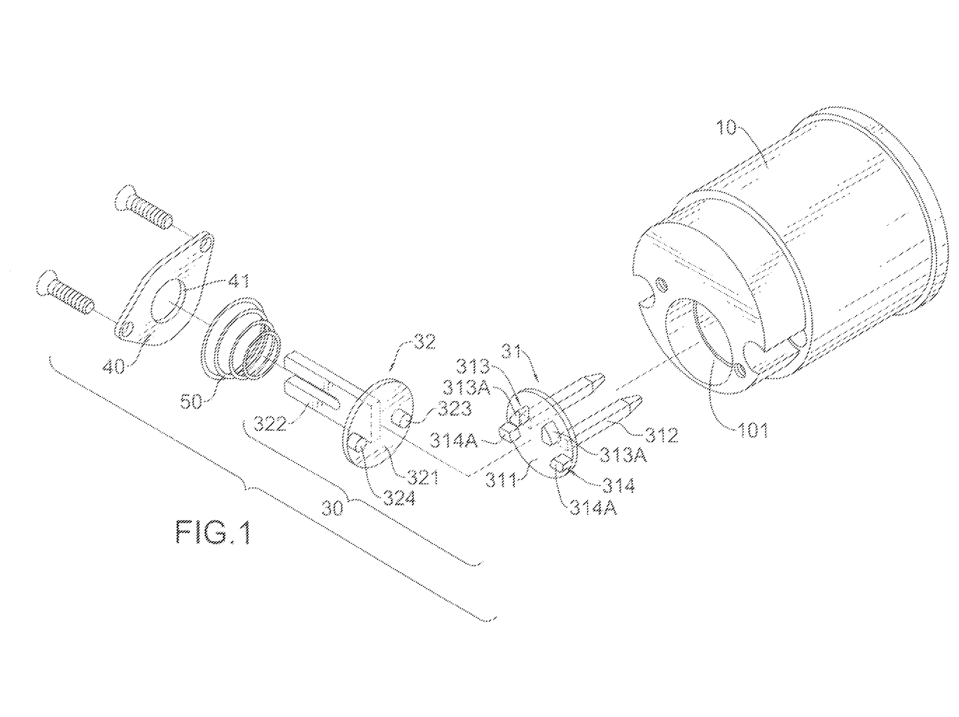

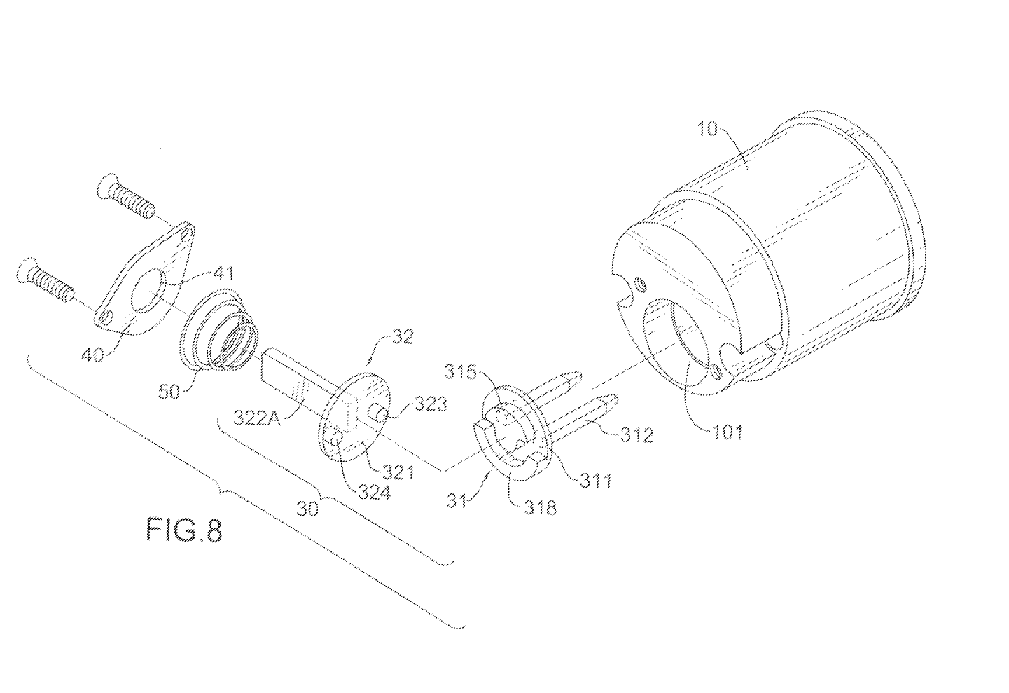

With reference to FIGS. 1, 4, 7 and 8, a lock comprises a cylindrical housing (10), a lock core assembly (20), a lock driving mechanism (30), a spring (50), a fastening member (40) and a latch bolt.

The cylindrical housing (10) is hollow, is mounted in a door and has an inner surface and a receiving hole (101). The receiving hole (101) is defined in the inner surface of the cylindrical housing (10).

The lock core assembly (20) is held rotatably in the cylindrical housing (10) and allows a corresponding key to be inserted into and rotate the lock core assembly (20).

The lock driving mechanism (30) is held rotatably in the receiving hole (101) in the cylindrical housing (10), connects to the lock core assembly (20), protrudes from the receiving hole (101), has an inner driving member (31) and an outer driving member (32).

The inner driving member (31) is held rotatably in the receiving hole (101) of the cylindrical housing (10) and has an inner panel (311), a lock core driver (312), an inner driver (313, 315) and an outer driver (314, 318).

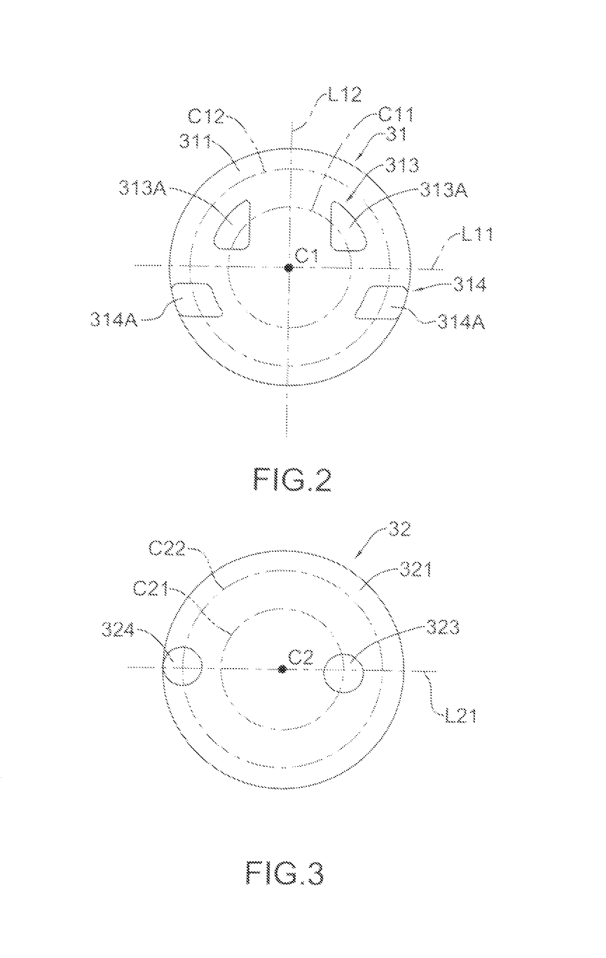

With further reference to FIG. 2, the inner panel (311) is held rotatably in the receiving hole (101) and has an inner surface, an outer surface, a center (C1), a first axis (L11), a second axis (L12), an imaginary inner circle (C11) and an imaginary outer circle (C12). The first axis (L11) and second axis (L12) intersect at the center (C1) of the inner panel (311) and are perpendicular to each other. The imaginary inner circle (C11) and imaginary outer circle (C12) are concentric circles centered at the center (C1) of the inner panel (311).

The lock core driver (312) has at least one inner arm extending from the inner surface of the inner panel (311) through the receiving hole (101) in the cylindrical housing (10) and being connected to the lock core assembly (20). When a key corresponding to the lock core assembly (20) is inserted into the lock core assembly (20) and is turned, the at least one inner arm of the lock core driver (312) is rotated to rotate the inner panel (311). One implementation of the lock core driver (312) has two inner arms. The two inner arms extend from the inner surface of the inner panel (311) through the receiving hole (101) in the cylindrical housing (10) and are connected to the rock core assembly (20). A key corresponding to the lock core assembly (20) is inserted into the lock core assembly (20) between the two inner arms. Turning the corresponding key simultaneously rotates the inner arms and inner panel (621).

The inner driver (313, 315) has two inner stop portions formed on the outer surface of the inner panel (311) on the imaginary inner circle (C11) on the inner panel (311) and being symmetric relative to the second axis (L12), and may be implemented in several ways.

With reference to FIGS. 1 and 2, a first implementation of the inner driver (313) includes two inner protruding sections (313A). The inner protruding sections (313A) are formed on the outer surface of the inner panel (311), on the imaginary inner circle (C11) on the inner panel (311), above the first axis (L11) and symmetric relative to the second axis (L12). The two inner stop portions are formed respectively on the protruding sections (313A).

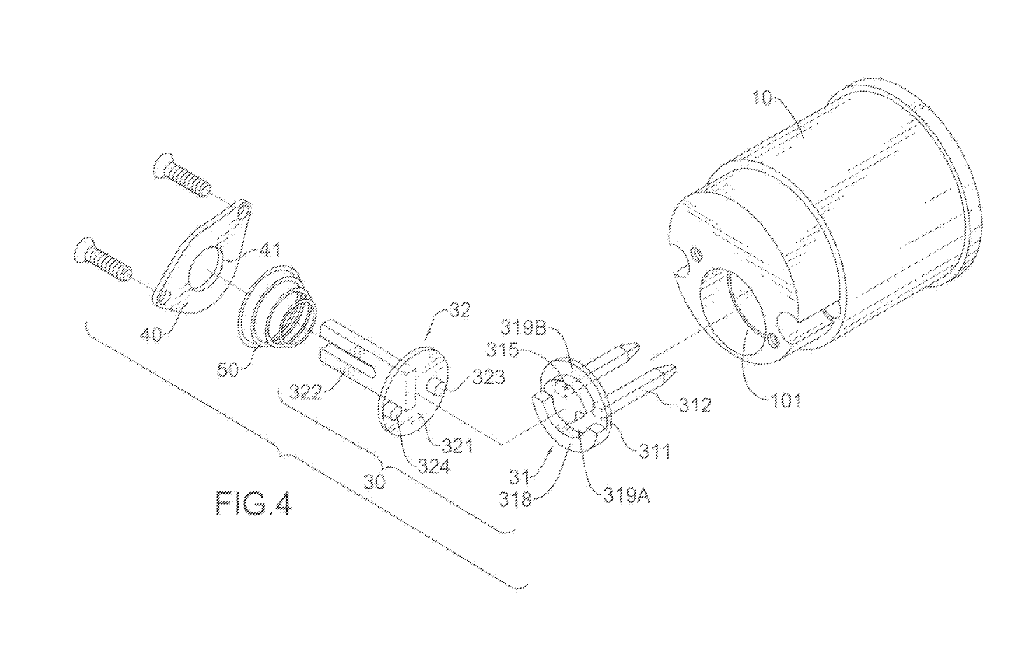

With reference to FIGS. 4, 6 and 8, a second implementation of the inner driver (315) is one piece and has a major semicircular body and a minor semicircular body. The major semicircular body is formed on the outer surface of the inner panel (311) above the first axis (L11), forms an upper semicircular track (319B) between the major semicircular body and the receiving hole (101) and has two shoulders. The shoulders align with the imaginary inner circle (C11) on the inner panel (311) above the first axis (L11) and are symmetric relative to the second axis (L12). The minor semicircular body extends downward between the shoulders. The two inner stop portions are formed respectively on the shoulders of the major semicircular body.

The outer driver (314, 318) has two outer stop portions formed on the outer surface of the inner panel (311), on the imaginary outer circle (C12) on the inner panel (311) and being symmetric relative to the second axis (L12), and may be implemented in several ways.

With reference to FIG. 2, a first implementation of the outer driver (314) includes two outer protruding sections (314A). The outer protruding sections (314A) are formed on the outer surface of the inner panel (311), on the imaginary outer circle (C12) on the inner panel (311), below the first axis (L11) and symmetric relative to the second axis (L12). The two outer stop portions are formed respectively on the outer protruding sections (314A).

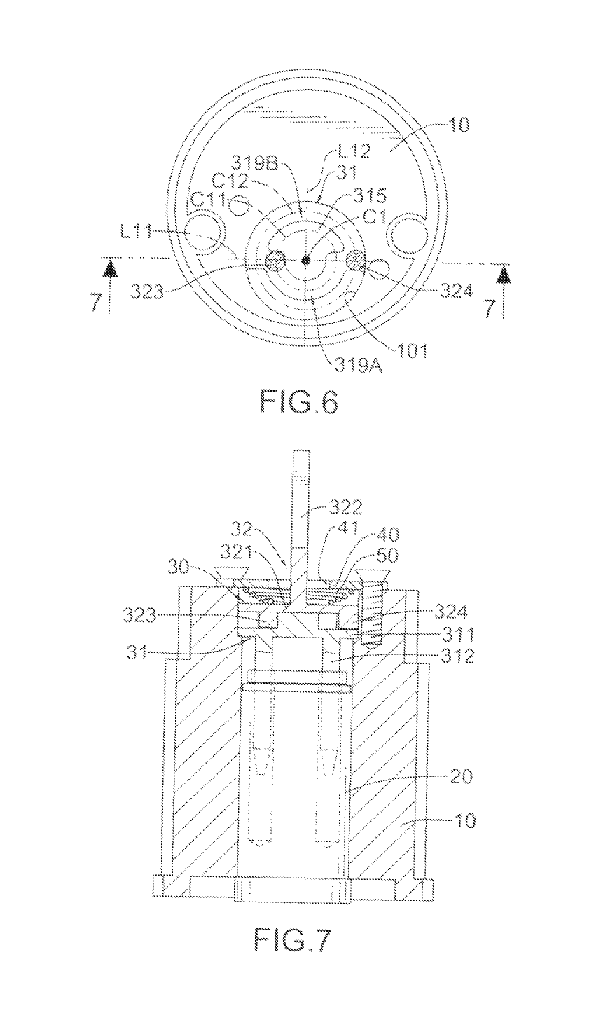

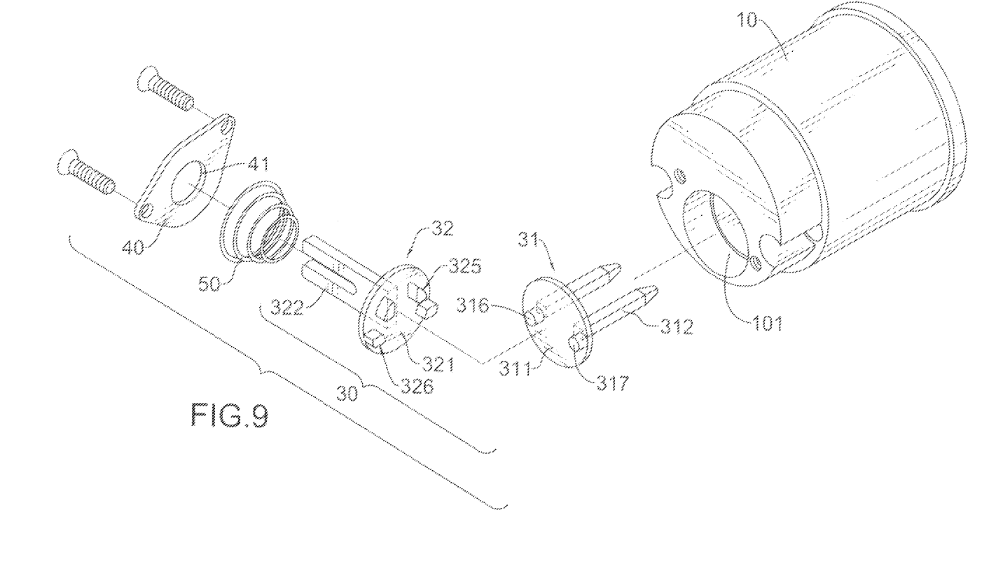

With reference to FIGS. 6 and 8, a second implementation of the outer driver (318) is a semicircular ring, is one piece, is formed below the first axis (L11), forms a lower semicircular track (319A) between the minor semicircular body and the semicircular ring and has two ends located on the imaginary outer circle of the inner panel and symmetric relative to the second axis (L12). The two stop portions are formed respectively on the ends of the semicircular ring.

The outer driving member (32) is held rotatably in the receiving hole (101) in the cylindrical housing (10), abuts, engages and is rotated by the inner driving member (31) and has a outer panel (321), an inner bump (323), an outer bump (324) and a latch driver (322, 322A).

With further reference to FIG. 3, the outer panel (321) is held rotatably in the receiving hole (101) and has an inner surface, an outer surface, a center (C2), a dividing axis (L21), an imaginary inner circle (C21) and an imaginary outer circle (C22). The center (C2) of the outer panel (321) corresponds to the center (C1) of the inner panel (311). The dividing axis (L21) passes through the center (C2) of the outer panel (321). The imaginary inner circle (C21) and imaginary outer circle (C22) on the outer panel (321) correspond respectively to the imaginary inner circle (C11) and imaginary outer circle (C12) on the inner panel (311).

The inner bump (323) is formed on the inner surface of the outer panel (321) on the imaginary inner circle (C21) and dividing axis (L21) on the outer panel (321).

The outer bump (324) is formed on the inner surface of the outer panel (321) on the imaginary outer circle (C22) and the first axis (L21) and opposite to the inner bump (323).

The outer panel (321) engages and is rotated by the inner panel (311) by one of the two inner stop portions of the inner drive (313, 315) abutting and pushing the inner bump (323). Simultaneously, one of the two outer stop portions of the outer driver (314, 318) abuts and pushes the outer bump (324). One of the inner stop portions and one of the outer stop portions abut simultaneously the inner bump (323) and outer bump (324) to rotate the outer panel (321) smoothly.

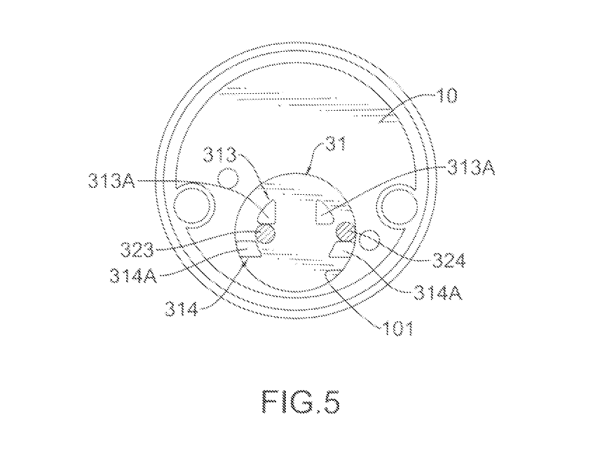

With further reference to FIG. 5, the outer panel (321) engages and is rotated by the first embodiment of the inner panel (311) by one of the inner protruding sections (313A) abutting and pushing the inner bump (323). Simultaneously, one of the outer protruding sections (314A) abuts and pushes the outer bump (324), which generates a moment around the center (C2) of the outer panel (321) and rotates the outer panel (321).

With further reference to FIG. 6, the outer panel (321) engages and is rotated by the second embodiment of the inner panel (311) by the inner bump (323) on the outer panel (321) sliding in the lower semicircular track (319A) and being abutted and pushed by one of the shoulders on the inner driver (315) on the inner panel (311). Simultaneously, the outer bump (324) slides in the upper semicircular track (319B) and is abutted and pushed by one end of the outer driver (318) on the inner panel (311), which generates a moment around the center (C2) of the outer panel (321) and rotates the outer panel (321).

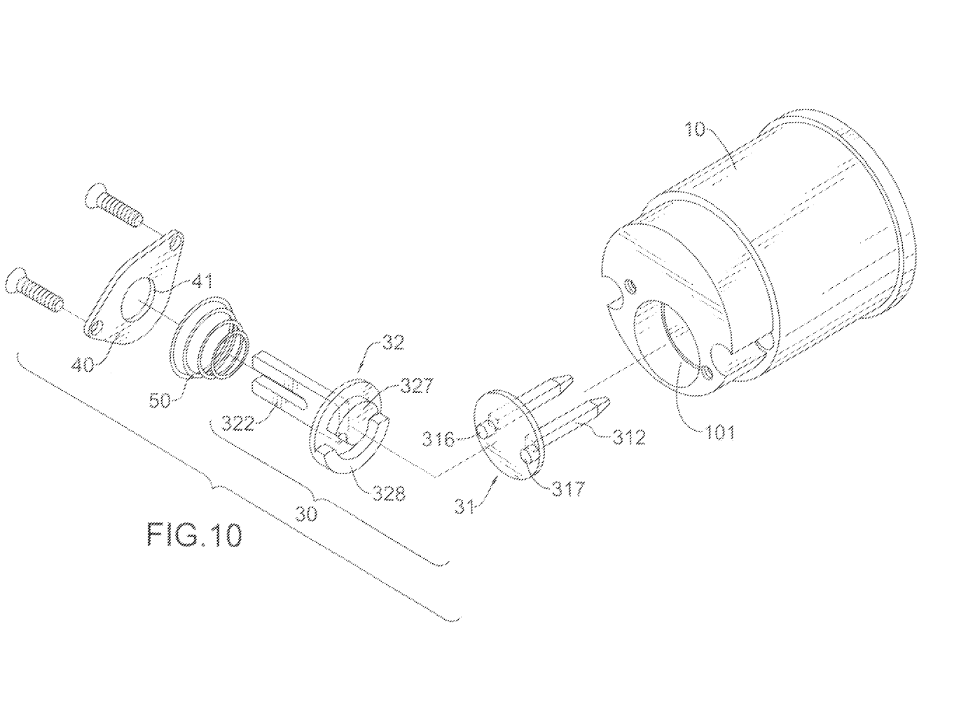

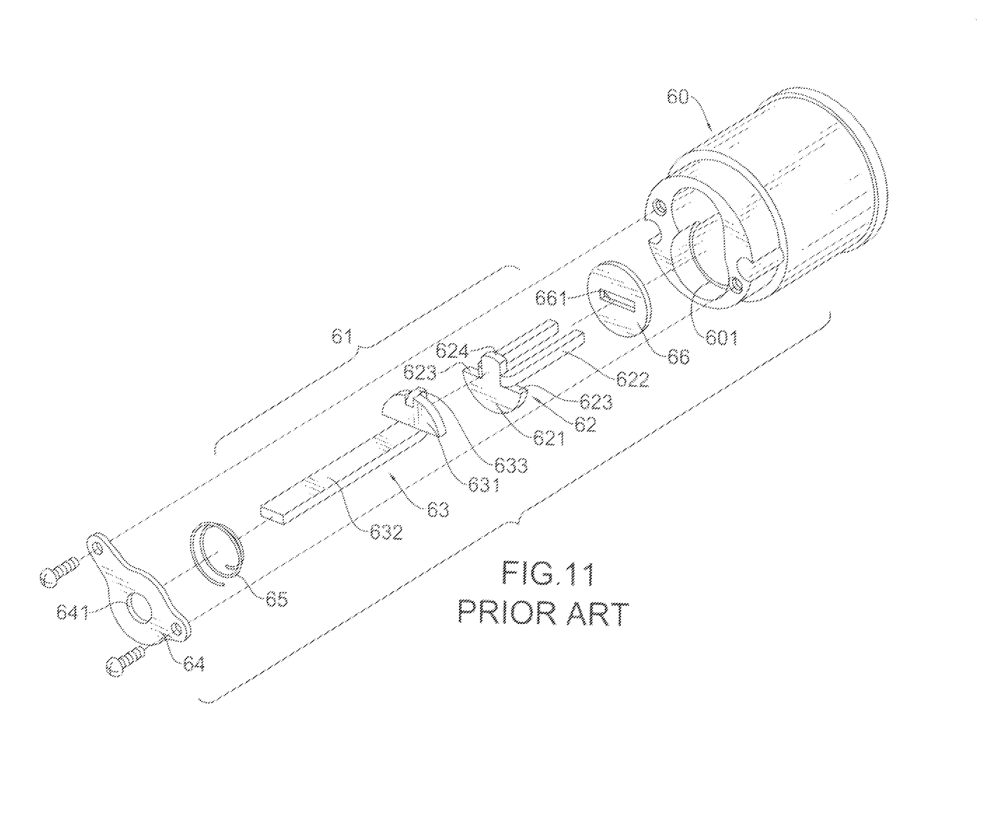

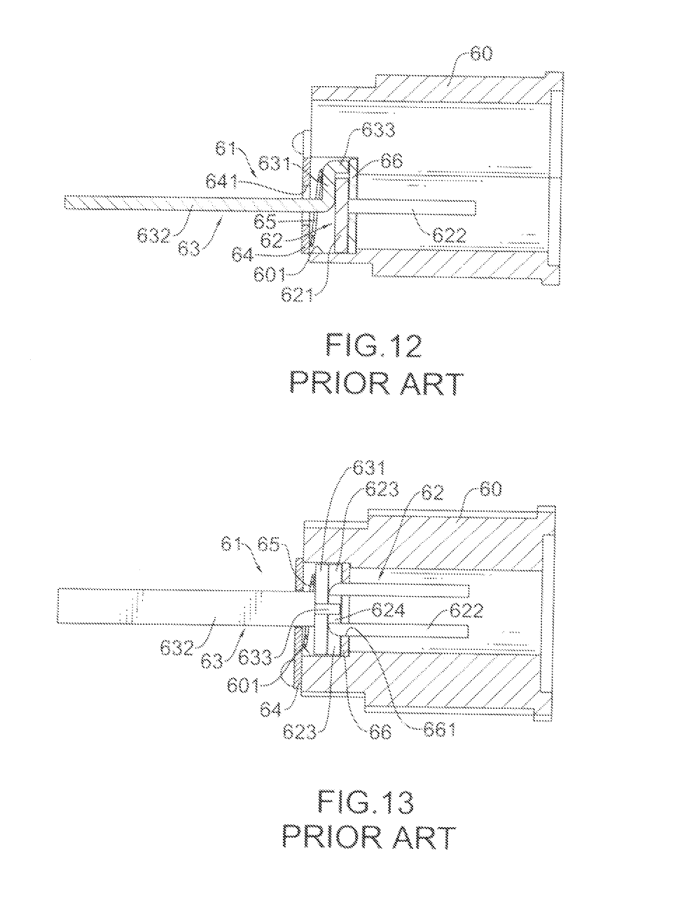

With reference to FIGS. 9 and 10, in alternative embodiments, the inner driver (325, 327) and outer driver (326, 328) are formed on the inner surface of the outer panel (321), and the inner bump (316) and outer bump (317) are formed on the outer surface of the inner panel (311). Likewise, the outer panel (321) engages and is rotated by the inner panel (311) by the inner bump (316) abutting and pushing the inner driver (325, 327) on the outer panel (321). Simultaneously, the outer bump (317) abutting and pushing the outer driver (326, 328) on the out panel (321).

The latch driver (322, 322A) has at least one outer arm extending from the outer surface of the outer panel (321) and may be implemented in several ways.

With reference to FIGS. 1 and 4, a first implementation of the latch driver (322) has two outer arms extending from the outer surface of the outer panel (321) and may be used with a lock having two keyholes in opposite ends of a lock.

With reference to FIG. 8, a second implementation of the latch driver (322A) only has a one-piece outer arm extending from the outer surface of the outer panel (321) and may be used with a lock having a single keyhole.

The spring (50) is mounted around the latch driver (322, 322A) against the outer panel (321) and presses the outer panel (321) against the inner panel (311).

The fastening member (40) is attached to the inner surface of the cylindrical housing (10), holds the spring (50) against the outer panel (321) and has a through hole (41). The through hole (41) allows the latch driver (322, 322A) of the outer driving member (32) to protrude from the cylindrical housing (10).

The latch bolt is connected to the latch driver (322, 322A) of the outer driving member (32) outside the cylindrical housing (10). The latch bolt is extended or retracted to respectively lock or unlock the door by rotating the latch driver (322, 322A).

When the corresponding key is inserted into the lock core assembly and rotated, the inner driver (313, 315) and outer driver (314, 318) rotate to synchronously engage and push the inner bump (323) and outer bump (324), respectively. Thus, a moment generated by the rotating corresponding key is divided between the inner bump (323) and outer bump (324), to make the corresponding key and latch driver (322, 322A) rotate smoothly to drive the latch bolt to lock or unlock the door.

1. A lock driving mechanism for use in a lock having a cylindrical housing having a hollow receiving hole, the lock driving mechanism held rotatably in the hollow receiving hole, and a fastening member mounted to the cylindrical housing to hold the lock driving mechanism in the hollow receiving hole, said lock driving mechanism comprising:
an inner driving member having an inner panel, said inner panel including an inner surface and an outer surface, an imaginary inner concentric circle and an imaginary outer concentric circle being provided on said outer surface of said inner panel;
a lock core driver having at least one inner arm extending from said inner surface of said inner panel;
an inner driver having two inner stop portions formed on said outer surface of said inner panel, said two inner stop portions being located on a track of said imaginary inner concentric circle of said outer surface of said inner panel;
an outer driver having two outer stop portions formed on said outer surface of said inner panel, said two outer stop portions being located on a track of said imaginary outer concentric circle of said outer surface of said inner panel;
an outer driving member coupled to said inner driving member and having an outer panel, said outer panel including an inner surface and an outer surface;
an inner bump formed on said inner surface of said outer panel;
an outer bump formed on said inner surface of said outer panel; and
a latch driver having at least one outer arm extending from said outer surface of said outer panel;
wherein said inner bump on said inner surface of said outer panel is located on a rotating track corresponding to said imaginary inner concentric circle of said outer surface of said inner panel when said outer panel is coupled to said inner panel;
wherein said outer bump on said inner surface of said outer panel is located on a rotating track corresponding to said imaginary outer concentric circle of said outer surface of said inner panel when said outer panel is coupled to said inner panel; and
wherein said inner stop portions of said inner driver and said outer stop portions of said outer driver are adapted to rotate said inner bump and outer bump respectively.

2. The lock driving mechanism as claimed in claim 1, wherein
said inner driver includes two inner protruding sections formed on said outer surface of said inner panel and located on said track of said imaginary inner concentric circle of said inner panel; and
said inner stop portions of said inner driver are located on said inner protruding sections respectively.

3. The lock driving mechanism as claimed in claim 1, wherein said inner driver is one piece and has
a major semicircular body formed on said outer surface of said inner panel and having two shoulders aligning with said track of said imaginary inner concentric circle of said inner panel, wherein said inner stop portions are located on said shoulders respectively; and
a minor semicircular body extending downward between said shoulders.

4. The lock driving mechanism as claimed in claim 1, wherein
said outer driver includes two outer protruding sections formed on said outer surface of said inner panel and located on said track of said imaginary outer concentric circle of said inner panel; and
said outer stop portions are located on said outer protruding sections respectively.

5. The lock driving mechanism as claimed in claim 2, wherein
said outer driver includes two outer protruding sections formed on said outer surface of said inner panel and located on said track of said imaginary outer concentric circle of said inner panel; and
said outer stop portions are located on said outer protruding sections respectively.

6. The lock driving mechanism as claimed in claim 1, wherein
said outer driver is a semicircular ring, is one piece and has two ends located on said track of said imaginary outer concentric circle of said inner panel; and
said outer stop portions of said outer driver are located on said two ends respectively.

7. The lock driving mechanism as claimed in claim 3, wherein
said outer driver is a semicircular ring, is one piece, and has two ends located on said track of said imaginary outer concentric circle of said inner panel, whereby a lower semicircular track is formed between said minor semicircular body and said semicircular ring; and
said outer stop portions of said outer driver are located on said two ends respectively.

8. The lock driving mechanism as claimed in claim 1, wherein said lock core driver has two inner arms extending from said inner surface of said inner panel.

9. The lock driving mechanism as claimed in claim 1, wherein said latch driver has two outer arms extending from said outer surface of said outer panel.

10. The lock driving mechanism as claimed in claim 1, wherein said latch driver has a single outer arm extending from said outer surface of said outer panel.

11. A lock driving mechanism for use in a lock having a cylindrical housing having a hollow receiving hole, a lock core assembly held in the hollow receiving hole, and the lock driving mechanism held rotatably in the hollow receiving hole and having a lock core driver connecting to the lock core assembly, the lock driving mechanism comprising:
an inner driving member comprising
an inner panel having an inner surface and an outer surface, wherein an imaginary inner concentric circle and an imaginary outer concentric circle are provided on said outer surface of said inner panel;
the lock core driver having at least one inner arm extending from said inner surface of said inner panel;
an inner bump formed on said outer surface of said inner panel and located on a track of said imaginary inner concentric circle of said inner panel; and
an outer bump formed on said outer surface of said inner panel and located on a track of said imaginary outer concentric circle of said inner panel; and
an outer driving member coupled to and being rotated by said inner driving member, said outer driving member comprising
an outer panel having an inner surface and an outer surface, wherein an imaginary inner concentric circle and an imaginary outer concentric circle are provided on said inner surface of said outer panel and correspond to said imaginary inner and outer concentric circles of said inner panel, respectively;
an inner driver provided with two inner stop portions formed on said inner surface of said outer panel and located on a track of said imaginary inner concentric circle of said outer panel;
an outer driver provided with two outer stop portions formed on said inner surface of said outer panel and located on a track of said imaginary outer concentric circle of said outer panel; and
a latch driver having at least one outer arm extending from said outer surface of said outer panel;
whereby said inner stop portions of said inner driver are located on a rotating track of said inner bump and said outer stop portions of said outer driver are located on a rotating track of said outer bump to limit the rotating of said inner bump and outer bump respectively.

12. The lock driving mechanism as claimed in claim 11, wherein
said inner driver of said outer panel includes two inner protruding sections formed on said inner surface of said outer panel and located on said track of said imaginary inner concentric circle of said outer panel; and
said inner stop portions of said inner driver are located on said inner protruding sections respectively.

13. The lock driving mechanism as claimed in claim 11, wherein said inner driver of said outer panel is one piece and has
a major semicircular body formed on said inner surface of said outer panel and having two shoulders aligning with said track of said imaginary inner concentric circle of said outer panel, wherein said inner stop portions are located on said shoulders respectively; and
a minor semicircular body extending downward between said shoulders.

14. The lock driving mechanism as claimed in claim 11, wherein
said outer driver of said outer panel includes two outer protruding sections formed on said inner surface of said outer panel and located on said track of said imaginary outer concentric circle of said outer panel; and
said outer stop portions are located on said outer protruding sections respectively.

15. The lock driving mechanism as claimed in claim 12, wherein
said outer driver of said outer panel includes two outer protruding sections formed on said inner surface of said outer panel and located on said track of said imaginary outer concentric circle of said outer panel; and
said outer stop portions are located on said outer protruding sections respectively.

16. The lock driving mechanism as claimed in claim 11, wherein
said outer driver of said outer panel is a semicircular ring, is one piece and has two ends located on said track of said imaginary outer concentric circle of said outer panel; and
said outer stop portions of said outer driver are located on said two ends respectively.

17. The lock driving mechanism as claimed in claim 13, wherein
said outer driver of said outer panel is a semicircular ring, is one piece, and has two ends located on said track of said imaginary outer concentric circle of said outer panel, whereby a lower semicircular track is formed between said minor semicircular body and said semicircular ring; and
said outer stop portions of said outer driver are located on said two ends respectively.

18. The lock driving mechanism as claimed in claim 11, wherein said lock core driver has two inner arms extending from said inner surface of said inner panel.

19. The lock driving mechanism as claimed in claim 11, wherein said latch driver has two outer arms extending from said outer surface of said outer panel.

20. The lock driving mechanism as claimed in claim 11, wherein said latch driver has a single outer arm extending from said outer surface of said outer panel.
